(19) United States
(12) Patent Application Publication
(10) Pub. No.: US 2020/0191100 A1
(43) Pub. Date: Jun. 18, 2020

(54) VEHICLE POWERTRAIN UNIT

(71) Applicant: MAZDA MOTOR CORPORATION, Hiroshima (JP)

(72) Inventors: Tomohiro KOGUCHI, Higashihiroshima-shi, Hiroshima (JP); Shinji FUJIHIRA, Hiroshima-shi, Hiroshima (JP); Ryotaro NISHIDA, Hiroshima-shi, Hiroshima (JP); Takeshi NAKAHIRA, Hiroshima-shi, Hiroshima (JP)

(73) Assignee: MAZDA MOTOR CORPORATION, Hiroshima (JP)

(21) Appl. No.: 16/641,171

(22) PCT Filed: Aug. 1, 2018
(86) PCT No.: PCT/JP2018/028901

§ 371 Date: Feb. 21, 2020

(30) Foreign Application Priority Data
Aug. 24, 2017 (JP) 2017-161494

(51) Int. Cl. F02M 26/28; F02M 26/41

(52) U.S. Cl. CPC F02M 26/28; F01L 1/356; F02M 26/41

(57) ABSTRACT

An engine (1) of a vehicle powertrain unit (P) includes: an electric exhaust S-VT (27) that is mounted on one end of an exhaust camshaft (26) and changes a rotational phase of the exhaust camshaft; and an EGR device (60) that is provided outside an engine body (10) and connects an intake passage (30) and an exhaust passage (50) together. The EGR device is located closer to a cylinder block (13) than the electric exhaust S-VT in a direction from a cylinder head (14) to the cylinder block, and is arranged so that at least a part of the EGR device and the electric exhaust S-VT overlap with each other when viewed in the direction from the cylinder head to the cylinder block.

### TECHNICAL FIELD

The present disclosure relates to a vehicle powertrain unit.

### BACKGROUND ART

Patent Document 1 discloses an example of an engine that configures a vehicle powertrain unit. Specifically, Patent Document 1 discloses an engine including an external exhaust gas recirculation (EGR) device connected to an intake passage and an exhaust passage. As illustrated in FIG. 1 of Patent Document 1, the external EGR device is provided at an end in the engine output shaft direction, that is, in the camshaft central axis direction.

### CITATION LIST

### Patent Document

Patent Document 1: Japanese Unexamined Patent Publication No. 2016-65465

### SUMMARY OF THE INVENTION

### Technical Problem

Engines including an external EGR device, such as the engine disclosed in Patent Document 1, may have a variable valve mechanism mounted to the engine in order to change a rotational phase of the camshaft. In general, such a variable valve mechanism is mounted to an end of the camshaft. Depending on how the variable valve mechanism is located in relation to the EGR device, in particular to the EGR cooler of the EGR device, the engine may increase in size. This is disadvantageous in downsizing the powertrain unit.

In view of the foregoing background, it is an object of the present disclosure to downsize the vehicle powertrain unit.

### Solution to the Problem

The technique disclosed herein is directed to a vehicle powertrain unit having an engine including: an engine body including a cylinder block and a cylinder head coupled to the cylinder block; a camshaft arranged at the cylinder head and extending in an engine front-rear direction; a variable valve mechanism that is mounted on one end of the camshaft and changes a rotational phase of the camshaft; an intake passage connected to one side face of the engine body and an exhaust passage connected to an opposite side face of the engine body; and an EGR device provided outside the engine body and connecting the intake passage and the exhaust passage together.

The EGR device is located closer to the cylinder block than the variable valve mechanism in a direction from the cylinder head toward the cylinder block, and is arranged so that at least a part of the EGR device and the variable valve mechanism overlap with each other when viewed in the direction from the cylinder head toward the cylinder block.

According to this configuration, the variable valve mechanism mounted on the engine inevitably protrudes from an end of the engine along the engine front-rear direction (that is, in the camshaft central axis direction). A space is defined below the protruding variable valve mechanism. Utilizing the space, the EGR device can be provided in the space.

In particular, at least a portion of the EGR device and the variable valve mechanism (that is, the portion protruding from the engine toward an end in the engine output shaft direction) are arranged to overlap with each other when viewed from the cylinder head toward the cylinder block. Such an arrangement can reduce the size of the engine in the engine front-rear direction. As a result, the powertrain unit can be downsized.

Hence, the variable powertrain unit can be downsized.

The EGR device may include an EGR passage connecting the intake passage and the exhaust passage together and an EGR cooler interposed in the EGR passage, and the EGR device may be arranged so that the EGR cooler and the variable valve mechanism overlap with each other when viewed in the direction from the cylinder head toward the cylinder block.

The EGR cooler generally has a cross-section perpendicular to the flow direction of the gas that is larger than the other elements that configure the EGR device, such as the EGR passage. According to this configuration, the engine, and hence the powertrain unit, is advantageously downsized by having the EGR cooler overlap with the variable valve mechanism.

The variable valve mechanism may be configured as an electric mechanism, and the EGR cooler and a portion of the EGR passage downstream of the EGR cooler may be arranged below the variable valve mechanism.

In general, when an electric variable valve mechanism is used, reduction in heat damage is required.

The EGR cooler can cool the gas that flows back as an external EGR gas. Thus, relatively lower temperature gas flows through the portion of the EGR passage downstream of the EGR cooler, compared to gas flowing through a portion of the EGR passage upstream of the EGR cooler.

According to this configuration, the portion having a relatively lower temperature in the EGR device is located below the variable valve mechanism. Hence, heat damage to the variable valve mechanism can be reduced.

The vehicle powertrain unit may include a transmission coupled to an end of the cylinder block in an engine output shaft direction, wherein the variable valve mechanism may be mounted to an end of the camshaft toward the transmission, and the EGR device may be arranged between the variable valve mechanism and the transmission.

According to this configuration, the variable valve mechanism is mounted to an end of the camshaft toward the transmission. As a result, the end protrudes from an end along the engine output shaft (i.e., the camshaft central axis direction), and the transmission is positioned below the end. A space is defined between the protruding portion and the transmission, and the EGR device is arranged in that space. Thus, the engine, and hence the powertrain unit, is advantageously downsized.

The EGR device may be supported by the transmission.

When a vehicle powertrain unit is to be serviced (in particular, when the engine valve system is to be replaced), the cylinder head may have to be removed. It is required that such servicing work be carried out smoothly even in a state in which the engine is mounted on the vehicle.

Generally, the EGR device such as the device disclosed in Patent Document 1 has been supported by the cylinder head. However, when the cylinder head is to be removed for service of the engine, such a configuration requires the EGR device to be removed in advance from the cylinder head.

The EGR device includes multiple devices such as an EGR passage connecting an exhaust passage and an intake passage of the engine, and an EGR cooler for cooling burned gas. Hence, removing the EGR device from the cylinder head takes time, and thus is inconvenient for smooth service of the engine. In such a case, a space is required to store the removed EGR device. In view of the extra space required, the EGR device has room for improvement for smooth serviceability.

The EGR device could be supported by the automotive body. However, such a support structure could transmit a vibration caused by an operation of the engine to the automotive body through the EGR device when the vibration enters the EGR device through the intake passage and the exhaust passage. The transmission of the vibration deteriorates noise vibration and harshness (NVH) characteristics of the vehicle, and is not preferable.

However, according to the configuration, the EGR device is supported not by the cylinder head but by the transmission. Hence, when the cylinder head is to be removed, such a configuration eliminates the need for a process of removing the EGR device from the cylinder head. As a result, the configuration successfully reduces the number of processes, improving serviceability of the powertrain unit.

Compared with a configuration of supporting the EGR device by the automotive body, supporting the EGR device by the transmission can reduce the transmission of the vibration through the EGR device. This is advantageous in ensuring NVH characteristics.

As a result, such a configuration successfully improves serviceability of the powertrain unit without deteriorating the NVH characteristics.

An engine compartment in which the engine is mounted may include: a hood arranged above the engine and rising from front to rear in a vehicle front-rear direction; and a partition arranged behind the engine and defining at least a rear face of the engine compartment, wherein the partition may include a tunnel located behind the engine and extending in the vehicle front-rear direction, the engine may be positioned so that the engine output shaft is arranged along the vehicle front-rear direction and that an end of the engine toward the variable valve mechanism is oriented to face the partition, and the transmission may be located behind the engine and is inserted in the tunnel.

The “partition” used herein may include at least one of a dash panel, a floor panel, and a cowl.

In recent years, the height of the hood has been required to be lowered in view of a sophisticated design and improved aerodynamic characteristics of the vehicle. Considering that a typical motor vehicle has the hood gradually rising from the front toward the rear, the powertrain unit needs to be provided toward the rear as much as possible, and such devices as the variable valve mechanism which could protrude above the cylinder head and the cylinder block are required to be provided to the rear of the engine in order to lower the overall height of the hood without changing the size of the powertrain unit itself.

According to the configuration described above, the engine is positioned so that the variable valve mechanism faces the dash panel arranged behind the engine. Such positioning of the engine is equivalent to providing the variable valve mechanism to the rear of the engine, which is advantageous in lowering the overall height of the hood.

Further, in such positioning of the engine, the variable valve mechanism and the EGR device located in relation to one another as described above contribute to reducing the size of the engine along the engine output shaft; that is, the vehicle front-rear direction. Hence, by the reduced size of the engine in the vehicle front-rear direction, the engine can be provided further toward the rear and closer to the partition. This allows the overall height of the hood to be lowered.

Moreover, when the transmission is inserted in the tunnel, the whole powertrain unit can be provided to the rear of the engine compartment. This is also advantageous in lowering the overall height of the hood.

A fuel pump may be attached to the engine, and the fuel pump may be arranged forward of an end face of the engine toward the transmission in the vehicle front-rear direction.

According to this configuration, the fuel pump is located forward of the end face of the engine toward the transmission. Such an arrangement is advantageous in reducing the risk of contact between the fuel pump and the dash panel when, for example, the vehicle comes into collision.

### Advantages of the Invention

As can be seen from the foregoing description, the vehicle powertrain unit described above can be downsized.

### BRIEF DESCRIPTION OF THE DRAWINGS

FIG. 1 schematically illustrates a vehicle in which a powertrain unit is mounted.

FIG. 2 illustrates the powertrain unit viewed from behind.

FIG. 3 illustrates the powertrain unit viewed from the left.

FIG. 4 illustrates a schematic layout of a powertrain unit for a front-engine, front-wheel drive (FF) vehicle.

FIG. 5 schematically illustrates a cooling circuit of the engine.

FIG. 6 illustrates a power transmission mechanism of the engine.

FIG. 7 illustrates a timing chain cover covering the power transmission mechanism.

FIG. 8 illustrates the timing chain cover with a second cover alone removed.

FIG. 9 illustrates how a variable valve mechanism and an EGR device are located in relation to each other when viewed from the left.

FIG. 10 illustrates how the variable valve mechanism and the EGR device are located in relation to each other when viewed from above.

FIG. 11 illustrates how the variable valve mechanism and the EGR device are located in relation to each other when viewed from the front.

FIG. 12 illustrates a support structure of the EGR device viewed from obliquely forward left.

FIG. 13 illustrates a support structure of the EGR device viewed from obliquely backward left.

The illustration shows a structure for introducing coolant into an EGR cooler.

FIG. 14 corresponds to FIG. 4 and illustrates a schematic layout of a powertrain unit for a front-engine, rear-wheel drive (FR) vehicle.

FIG. 15 corresponds to FIG. 4 and illustrates a schematic layout of a powertrain unit for a hybrid vehicle (HV).

### DETAILED DESCRIPTION

Embodiments of a vehicle powertrain unit will be described in detail below, with reference to the drawings. The following description is only an example.

### First Embodiment

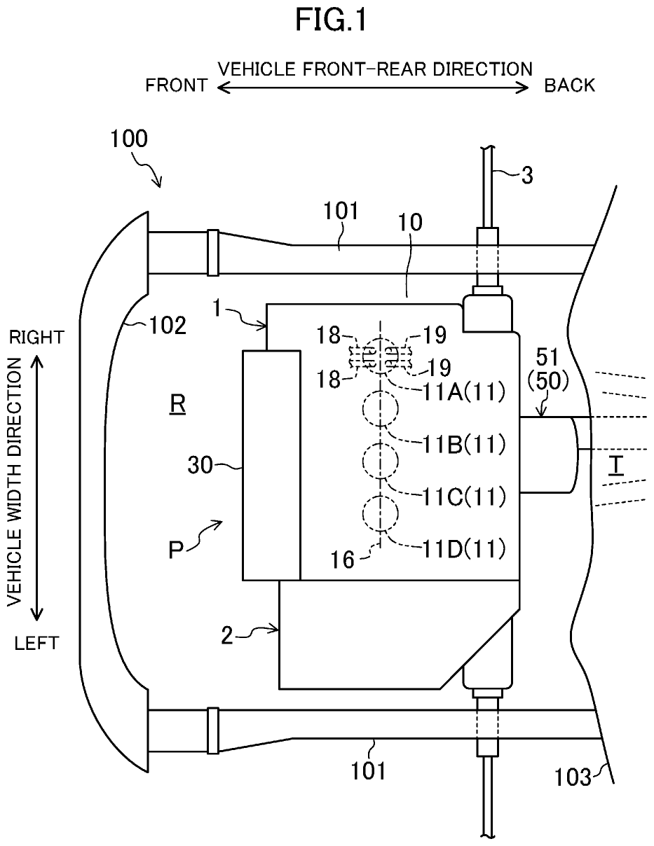

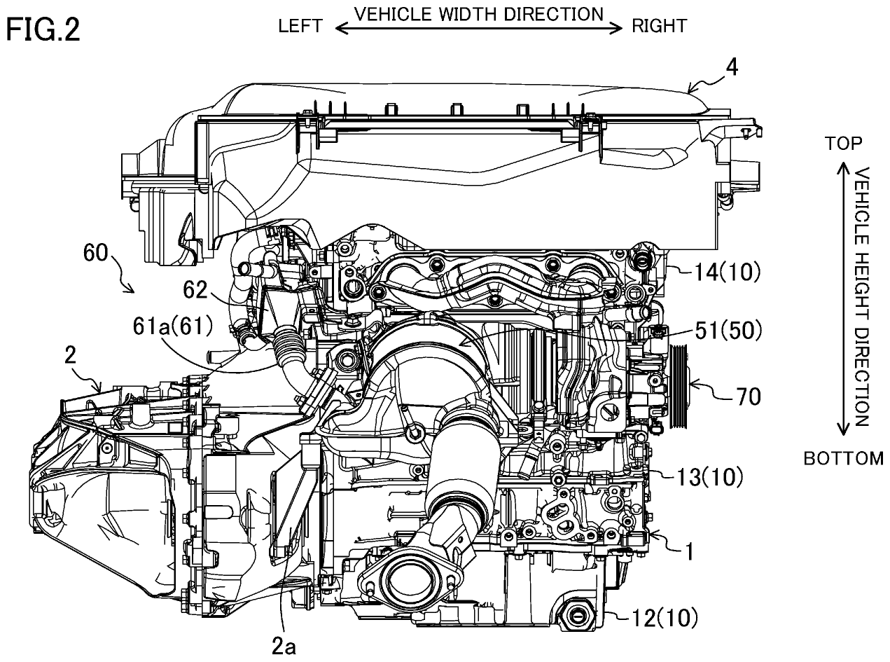

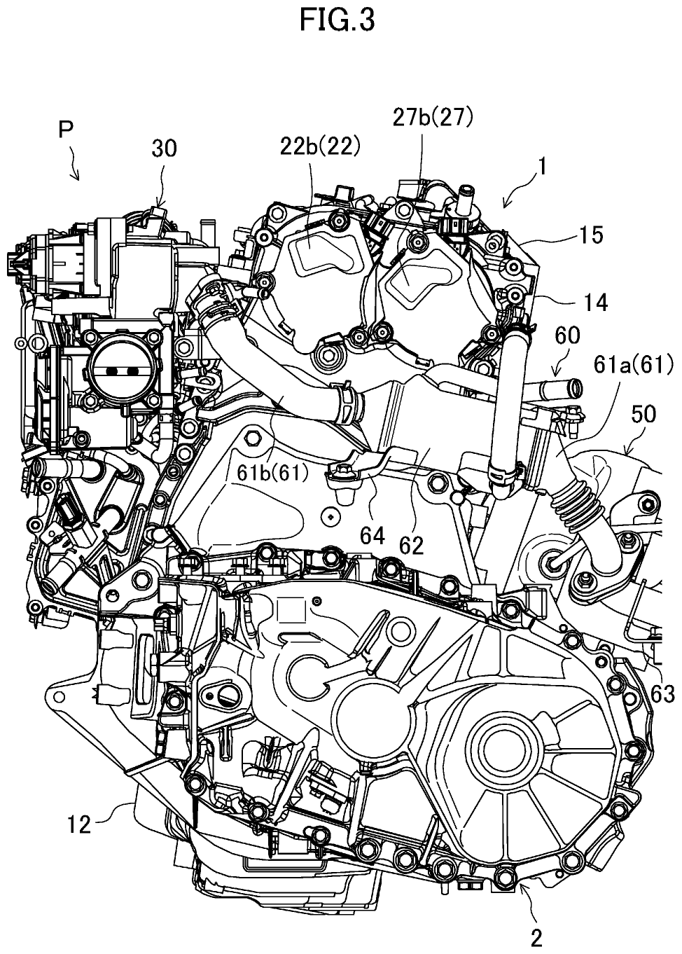

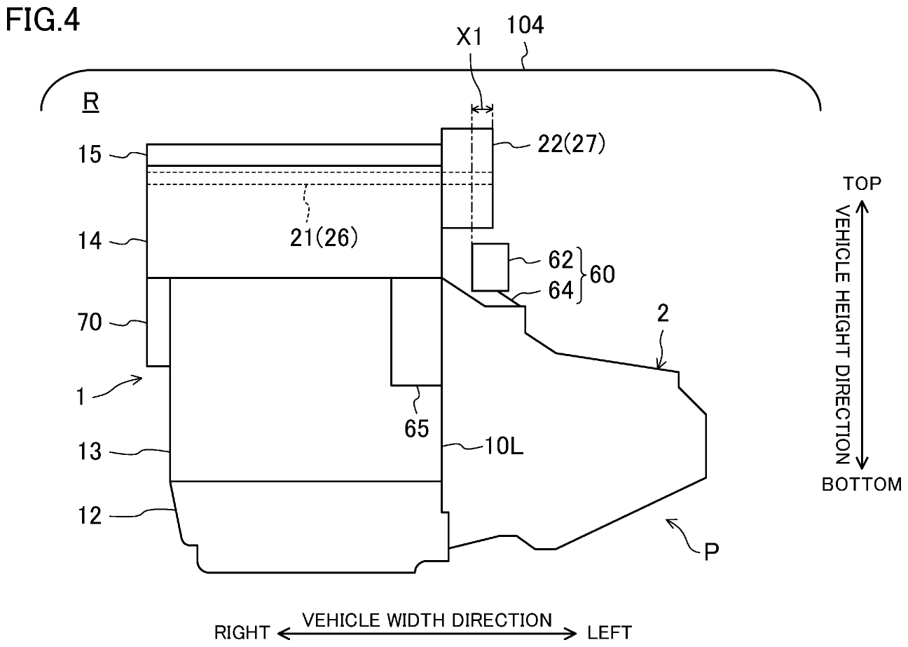

As a first embodiment, described first is a powertrain unit P mounted in a front-engine, front-wheel drive, four-wheel vehicle (i.e., an FF vehicle). FIG. 1 illustrates a front part of a motor vehicle (vehicle) 100 in which a powertrain unit P disclosed herein is mounted. FIG. 2 illustrates the powertrain unit P viewed from behind. FIG. 3 illustrates the powertrain unit P viewed from the left. FIG. 4 schematically illustrates a main layout of the powertrain unit P for the FF vehicle.

(Schematic Configuration of Powertrain Unit)

The powertrain unit P includes an engine 1 and a transmission 2 coupled to the engine 1. The engine 1 is a four-stroke gasoline engine, and capable of both spark ignition combustion and compression ignition combustion. Meanwhile, the transmission 2 is, for example, a manual transmission. The transmission 2 transmits power of the engine 1 to rotate and drive a drive shaft 3.

The motor vehicle 100 provided with the powertrain unit P is an FF vehicle. Specifically, the powertrain unit P, the drive shaft 3, and driving wheels (i.e., front wheels) coupled to the drive shaft 3 are all arranged in the front of the motor vehicle 100.

The automotive body of the motor vehicle 100 includes multiple frames. In particular, the front part of the automotive body includes: a pair of side frames 101 on the right-hand side and the left-hand side each provided to either side along the vehicle width, and extending in a front-rear direction of the motor vehicle 100; and a front frame 102 provided between front ends of the pair of side frames 101.

The automotive body has an engine compartment R, and the powertrain unit P is mounted in the engine compartment R. As shown in FIGS. 1 and 4, the engine compartment R includes: a hood 104 provided above the powertrain unit P; and a dash panel 103 provided behind the engine 1 and separating the engine compartment R from a cabin for accommodating an occupant. Note that the dash panel 103 is an example of a “partition” provided behind the engine 1 and defining a rear face of the engine compartment R. The partition is not limited to the dash panel 103, and can be configured as at least one of a plurality of members, such as a cowl (not shown) located above the dash panel 103 or a floor panel (not shown).

Although not illustrated in the first embodiment, the hood 104 gradually rises from the front to the rear in the vehicle front-rear direction.

Moreover, as illustrated in FIG. 1, the dash panel 103 is provided with a tunnel T extending in the vehicle front-rear direction. The tunnel T is provided with a duct for guiding exhaust gas to a muffler, and lets aerodynamic drag flow out of the engine compartment R while the vehicle is running

The engine 1 is a so-called in-line four-cylinder transverse engine including four cylinders 11 arranged in line along the vehicle width. In this embodiment, the engine front-rear direction, along which the four cylinders 11 are arranged (along a cylinder bank), is substantially the same as the vehicle width direction, while the engine width direction is substantially the same as the vehicle front-rear direction.

Note that, in an in-line multi-cylinder engine, the cylinder bank, the central axis of a crankshaft 16 acting as an engine output shaft (an engine output shaft direction), and a central axis for each of an intake camshaft 21 and an exhaust camshaft 26 coupled to the crankshaft 16 run in the same direction. Hereinafter, the direction may be referred to as the cylinder bank direction (or the vehicle width direction).

Unless otherwise noted, the term “front” means either side in the engine width direction (to the front in the vehicle longitudinal direction), the term “rear” means the other side in the engine width direction (to the rear in the vehicle longitudinal direction), the term “left” means either side in the engine longitudinal direction (the cylinder bank direction) (to the left of the vehicle width direction, to the rear of the engine, and to the transmission 2 of the powertrain unit P), and the term “right” means the other side in the engine longitudinal direction (the cylinder bank direction) (to the right in the vehicle width direction, to the front of the engine, and to the engine 1 of the powertrain unit P).

In the description below, the term “upper side” means an upper side in the vehicle height direction when the powertrain unit P is mounted in the motor vehicle 100 (hereinafter also referred to as an “in-vehicle mounted state”), and the term “lower side” means a lower side in the vehicle height direction when the powertrain unit P is mounted in the motor vehicle 100.

Meanwhile, the transmission 2 is coupled to an end of the engine 1 along the engine output shaft. In the engine 1, the transmission 2 is adjacent to a cylinder block 13, not to a cylinder head 14. Specifically, the transmission 2 is mounted to a left side face of the engine 1, and adjacent to the engine 1 in the cylinder bank direction. Whereas, in the vehicle height direction, the transmission 2 is provided below the cylinder head 14 (specifically, as illustrated in FIG. 4, the intake camshaft 21 and the exhaust camshaft 26 rotatably supported by the cylinder head 14) of the engine 1.

Moreover, an engine cover 4 is provided above the engine 1 (specifically, above the cylinder head 14) to cover the engine 1. The engine cover 4 guides the aerodynamic drag, flowing along a bottom face of the engine cover 4, toward the rear of the engine 1 (illustrated only in FIG. 2).

(Schematic Configuration of Engine)

Described next is schematic configuration of the engine 1 included in the powertrain unit P.

In this exemplary configuration, the engine 1 is of a front-intake and rear-exhaust type. Specifically, the engine 1 includes an engine body 10, an intake passage 30, and an exhaust passage 50. The engine body 10 includes the four cylinders 11. The intake path 30 is located in front of the engine body 10 and communicates with the cylinders 11 via intake ports 18.The exhaust path 50 is located behind the engine body 10 and communicates with the cylinders 11 via exhaust ports 19.

The intake passage 30 conducts gas (fresh air) introduced from outside, and supplies the gas inside the cylinders 11 of the engine body 10. In this exemplary configuration, the intake passage 30 is an intake system provided in the front of the engine body 10. The intake system is a combination of (i) multiple passages guiding the gas and (ii) devices such as a supercharger and an intercooler.

The engine body 10 burns in the cylinders 11 a mixture of fuel and the gas supplied from the intake passage 30. Specifically, the engine body 10 includes: an oil pan 12; the cylinder block 13 mounted on the oil pan 12; the cylinder head 14 placed on and coupled to the cylinder block 13; and a head cover 15 formed to overlie the cylinder head 14. The oil pan 12, the cylinder block 13, the cylinder head 14, and the head cover 15 are arranged in this order from bottom to top. Power generated through the combustion of the air-fuel mixture is delivered to the outside through the crankshaft 16 provided in the cylinder block 13.

Inside the cylinder block 13, the four cylinders 11 are formed. The four cylinders 11 are arranged in a line along the central axis of the crankshaft 16 (i.e., along the cylinder bank). Each of the four cylinders 11 has a cylindrical shape. The central axes of the cylinders 11 (hereinafter referred to as “cylinder axes”) extend parallel to one another, and run perpendicularly to the cylinder bank direction. The four cylinders 11 shown in FIG. 1 may be hereinafter referred to as a first cylinder 11A, a second cylinder 11B, a third cylinder 11C, and a fourth cylinder 11D in this order from the right along the cylinder bank.

In the cylinder head 14, two intake ports 18 are provided for each cylinder 11 (shown only for the first cylinder 11A). The two intake ports 18 are arranged side by side along the cylinder bank, and communicate with the cylinder 11.

The two intake ports 18 are each provided with an intake valve (not shown). The intake valves open and close between a combustion chamber defined in the cylinder 11 and the intake ports 18. The intake valves are opened and closed by an intake valve train mechanism 20 at predetermined timing.

In this exemplary configuration, as illustrated in FIG. 4, the intake valve train mechanism 20 includes: an intake camshaft (camshaft) 21; and an electric intake sequential-valve timing (S-VT) 22 acting as a variable valve train mechanism changing a rotational phase of the intake camshaft 21. The electric intake S-VT 22 is an exemplary additional device of the engine 1.

The intake camshaft 21 is provided inside the cylinder head 14, and rotatably supported in an orientation in which the central axis of the intake camshaft 21 and the engine output shaft run substantially in the same direction. The intake camshaft 21 is coupled to the crankshaft 16 through the power transmission mechanism 40 including a timing chain 41. The power transmission mechanism 40 transmits the power of the crankshaft 16 to the intake camshaft 21. As is commonly known, the power transmission mechanism 40 provides the intake camshaft 21 with a single turn while the crankshaft 16 makes two turns.

As illustrated in FIG. 4, the electric intake S-VT 22 is mounted on an end of the intake camshaft 21 toward the transmission 2 (i.e., a left end), and protrudes from a left side face of the cylinder head 14. Moreover, as illustrated in FIG. 4, the electric intake S-VT 22 is located near a boundary between the cylinder head 14 and the head cover 15 in the vehicle height direction, and protrudes at least above the cylinder head 14. Meanwhile, in the vehicle front-rear direction, the electric intake S-VT 22 is located in the front of the cylinder head 14 as illustrated in FIG. 3.

The electric intake S-VT 22 includes: a sprocket gear 22a around which the timing chain 41 is wrapped, the sprocket gear 22a rotating in conjunction with the crankshaft 16; a camshaft gear configured to rotate in conjunction with the camshaft; a planetary gear for adjusting a rotational phase of the camshaft gear in relation to the sprocket gear 22a; and an S-VT motor 22b driving the planetary gear. A detailed illustration of the electric intake S-VT 22 shall be omitted. The S-VT motor 22b is provided to a distal end of the electric intake S-VT 22 toward the transmission 2.

The electric intake S-VT 22 continuously changes a rotational phase of the intake camshaft 21 within a predetermined angular range. Accordingly, an opening time point and a closing time point of the intake valve change continuously. Note that the intake valve train mechanism 20 may include a hydraulic S-VT instead of the electric intake S-VT.

The cylinder head 14 also has two exhaust ports 19 provided for each cylinder 11. The two exhaust ports 19 communicate with the cylinder 11.

The two exhaust ports 19 are each provided with an exhaust valve (not shown). The exhaust valves open and close between the combustion chamber defined in the cylinder 11 and the exhaust port 19. The exhaust valves are opened and closed by an exhaust valve train mechanism 25 at predetermined timing.

In this exemplary configuration, as illustrated in FIG. 4, the exhaust valve train mechanism 25 includes: an exhaust camshaft (camshaft) 26; and an electric exhaust sequential-valve timing (S-VT) 27 acting as a variable valve train mechanism changing a rotational phase of an exhaust camshaft 26. The electric exhaust S-VT 27 is also an exemplary additional device of the engine 1.

The exhaust camshaft 26 is provided inside the cylinder head 14, and rotatably supported in a similar orientation as the intake camshaft 21 is supported. Specifically, the exhaust camshaft 26 is oriented in parallel with the intake camshaft 21, and placed behind, and adjacent to, the intake camshaft 21. The exhaust camshaft 26 is driven by the power transmission mechanism 40 to pivot.

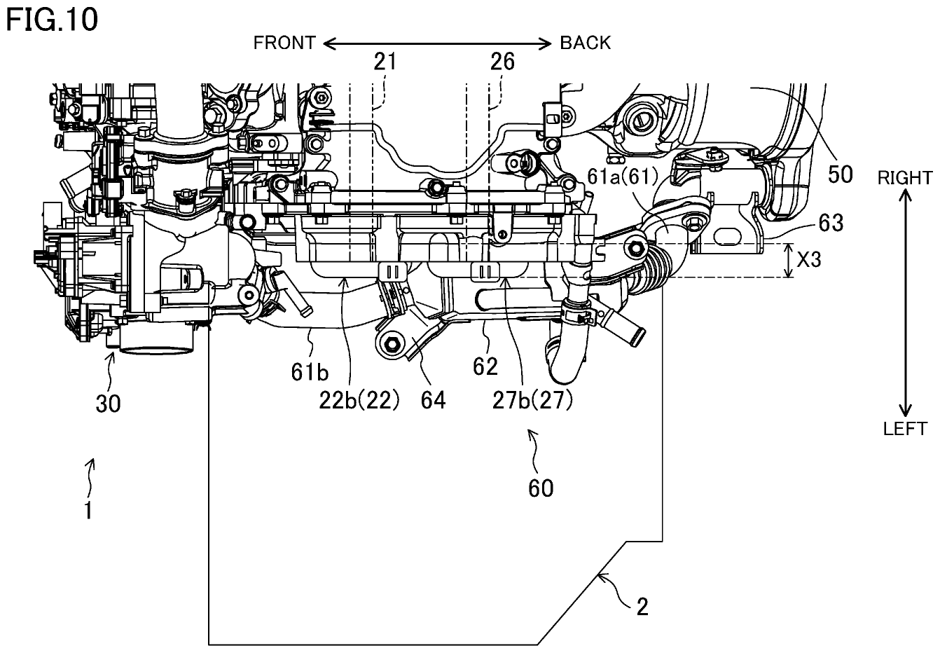

The electric exhaust S-VT 27 is also mounted on an end of the exhaust camshaft 26 toward the transmission 2 (i.e., the left end), and protrudes from the left side face of the cylinder head 14 (see also FIG. 10.) Similar to the electric intake S-VT 22, the electric exhaust S-VT 27 is located near the boundary between the cylinder head 14 and the head cover 15 in the vehicle height direction, and protrudes at least above the cylinder head 14. Meanwhile, in the vehicle front-rear direction as illustrated in FIG. 3, the electric exhaust S-VT 27 is located in the back of the cylinder head 14, and adjacent to the electric intake S-VT 22 in the front-rear direction.

The electric exhaust S-VT 27 includes a sprocket gear 27a and an S-VT motor 27b. The S-VT motor 27b is provided to a distal end of the electric exhaust S-VT 27 toward the transmission 2. The details of the electric exhaust S-VT 27 shall be omitted.

The exhaust passage 50 conducts exhaust gas discharged from the engine body 10 along with the combustion of the air-fuel mixture. Specifically, the exhaust passage 50 is provided behind the engine body 10, and communicates with the exhaust ports 19 of each cylinder 11. The exhaust passage 50 is provided with an exhaust emission control device 51 through a not-shown exhaust manifold.

In this exemplary configuration, the exhaust passage 50 is an exhaust system including a combination of (i) multiple passages guiding the gas and (ii) the exhaust emission control device 51.

As shown in FIG. 1, the intake passage 30 is connected to a side face in the front of the engine body 10 (one side face), and the exhaust passage 50 is connected to a side face in the rear of the engine body 10 (side face opposite to the one side face). Outside the engine body 10 (on the left in FIG. 10), an EGR device 60 is provided to connect the intake passage 30 and the exhaust passage 50 together. The EGR device 60 allows part of the burned gas to flow back to the intake passage 30 as external EGR gas. Specifically, the EGR device 60 includes an EGR passage 61 that connects the intake passage 30 and the exhaust passage 50, and an EGR cooler 62 that is interposed in the EGR passage 61.

The EGR passage 61 allows the burned gas, guided through the exhaust passage 50, to flow back to the intake passage 30. The EGR passage 61 has an upstream end connected to the exhaust passage 50 downstream of the exhaust emission control device 51. The EGR passage 61 has a downstream end connected to the intake passage 30 downstream of a throttle valve (not shown).

The EGR cooler 62 is of a water-cooling type such that the coolant supplied from a water pump (an accessory) 71 circulates in the EGR cooler 62. The EGR cooler 62 cools the burned gas guided through the exhaust passage 50.

Cooling Circuit of Engine

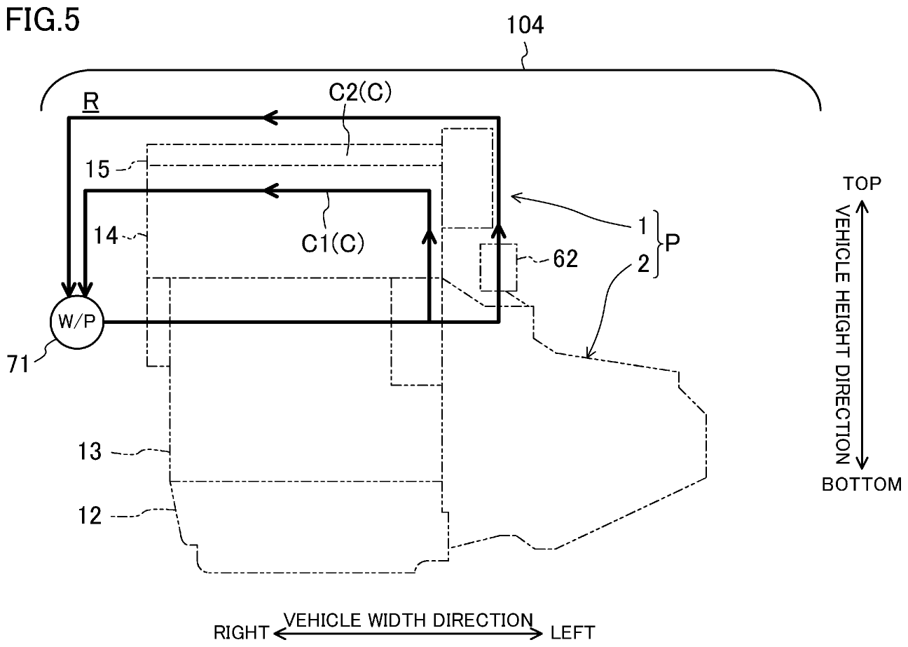

FIG. 5 schematically illustrates a cooling circuit C of the engine 1.

As illustrated in FIG. 5, the engine 1 has a cooling circuit C including: a first circuit C1 in which the coolant discharged mainly from the water pump 71 passes through a block water jacket formed in the cylinder block 13 and then through a head water jacket formed in the cylinder head 14, and is sucked into the water pump 71; and a second circuit C2 branching off from the block water jacket in the first circuit C1, so that the coolant discharged from the water pump 71 bypasses the head water jacket and is sucked into the water pump 71.

As illustrated in FIG. 5, the EGR cooler 62 is interposed in the second circuit C2. In addition, the EGR cooler 62 is connected to the second circuit C2 directly downstream of the head water jacket. Hence, the coolant flowing out of the EGR cooler 62 passes through a not-shown heater core, and then is sucked into the water pump 71.

Note that the cooling circuit C includes a third circuit provided separately from the first circuit C1 and the second circuit C2. The third circuit branches off from the head water jacket in the first circuit C1, so that the coolant passes through a throttle valve and a water jacket formed around the exhaust ports 19 and is sucked into the water pump 71. The details of the third circuit shall be omitted.

The engine 1 illustrated in FIG. 4 is provided with a fuel pump 65, as an example of a kind of an accessory, for pressure feeding the fuel. As illustrated in FIG. 4, the fuel pump 65 is provided across an end face (i.e., a left side face 10L), of the engine 1 toward the transmission 2, from the transmission 2 in the cylinder bank direction.

(Configuration around Transmission)

As already described, the transmission 2 is mounted on the left side face of the above engine 1. Described below is a configuration of the engine 1 around the transmission 2 in a sequential order.

Power Transmission Mechanism

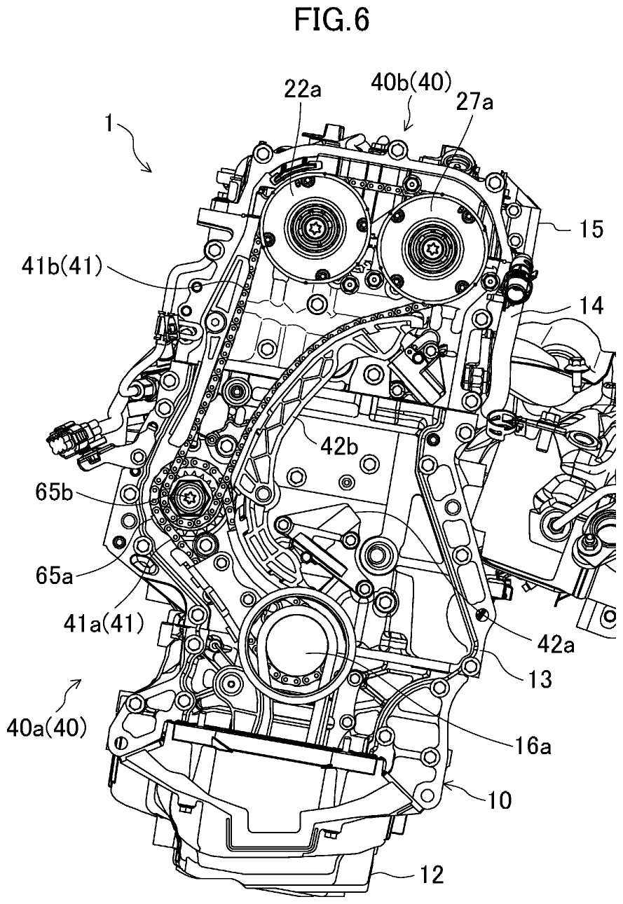

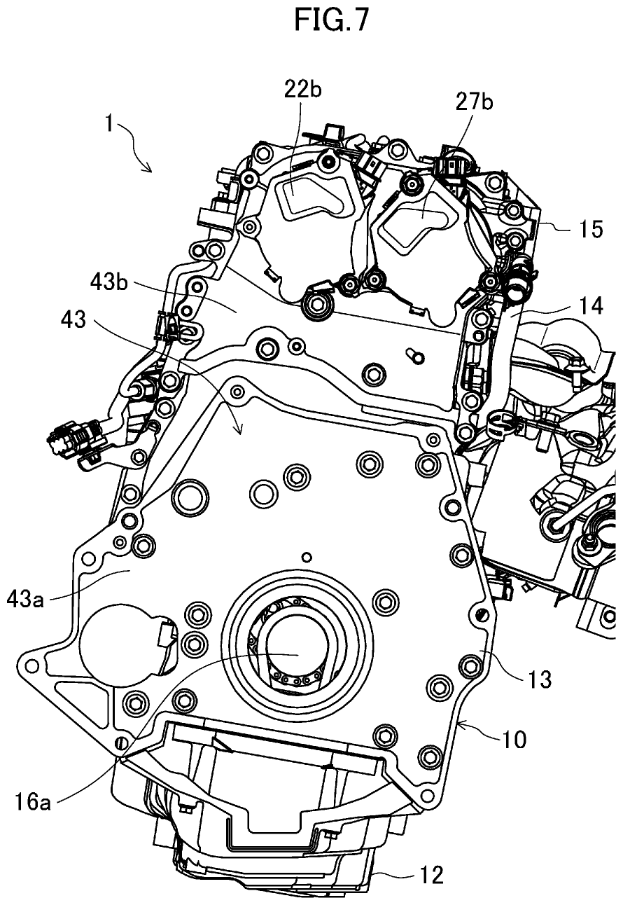

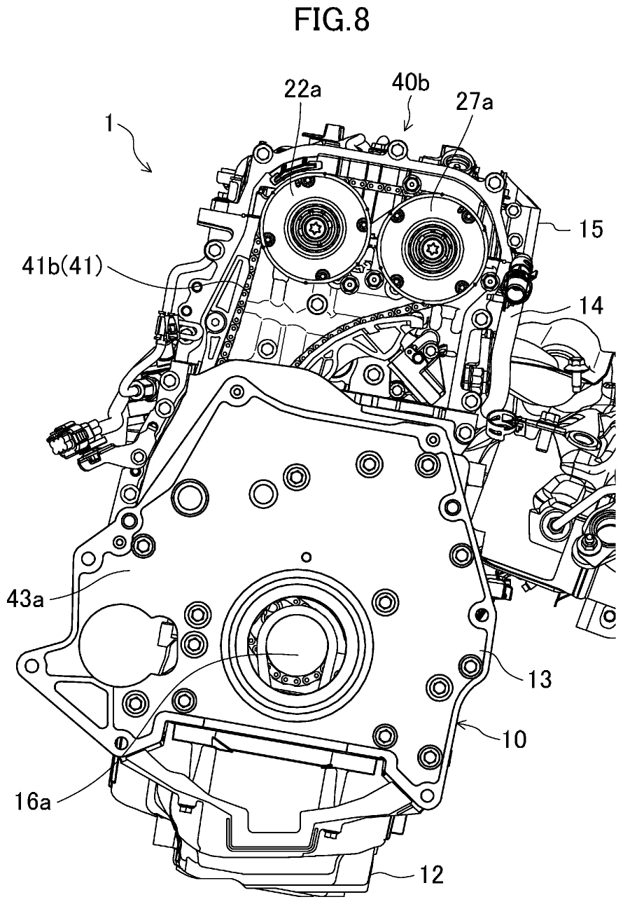

FIG. 6 illustrates the power transmission mechanism 40 of the engine 1. FIG. 7 illustrates a timing chain cover 43 covering the power transmission mechanism 40. FIG. 8 illustrates the timing chain cover 43 with a second cover 43b alone removed.

The power transmission mechanism 40 is a gear drive system through the timing chain 41, and is provided to a side face of the engine 1 toward the transmission 2 (specifically, to a left side face of the engine 1). In other words, the power transmission mechanism 40 is located between the engine 1 and the transmission 2 in the vehicle width direction.

The power transmission mechanism 40 drives various constituent elements such as the intake camshaft 21 and the exhaust camshaft 26. Specifically, the power transmission mechanism 40 includes: a first drive mechanism 40a for driving the fuel pump 65; and a second drive mechanism 40b for driving the intake camshaft 21 and the exhaust camshaft 26. Here, the timing chain 41 has two chains: a first chain 41a for transmitting power in the first drive mechanism 40a; and a second chain 41b for transmitting power in the second drive mechanism 40b.

Specifically, the first drive mechanism 40a has: a first sprocket 16a provided to a left end of the crankshaft 16; a second sprocket 65a provided to a left end of the fuel pump 65; the first chain 41a wrapped between the first sprocket 16a and the second sprocket 65a; and a first automatic tensioner 42a providing tension to the first chain 41a.

Specifically, as seen from FIG. 6, the first sprocket 16a is located in a lower half of the cylinder block 13 in the vehicle height direction, and in the center of the cylinder block 13 in the vehicle longitudinal direction.

Whereas, the second sprocket 65a is located in the center of the cylinder block 13 in the vehicle height direction, and at a front end of the cylinder block 13 in the vehicle front-rear direction.

Meanwhile, the second drive mechanism 40b has: a third sprocket 65b provided in the fuel pump 65 in the left and an inner periphery of the second sprocket 65a; a sprocket gear 22a included in the electric intake S-VT 22; a sprocket gear 27a included in the electric exhaust S-VT 27; a second chain 41b wrapped among the third sprocket 65b and the sprocket gears 22a and 27a; and a second automatic tensioner 42b providing tension to the second chain 41b.

Specifically, similar to the second sprocket 65a, the third sprocket 65b is located in the center of the cylinder block 13 in the vehicle height direction, and in the front end of the cylinder block 13 in the vehicle front-rear direction.

Moreover, similar to the electric intake S-VT 22 and the electric exhaust S-VT 27, the sprocket gears 22a and 27a are located near a boundary between the cylinder head 14 and the head cover 15 in the vehicle height direction, and provided above the cylinder head 14. Meanwhile, in the vehicle longitudinal direction, the sprocket gears 22a and 27a are arranged in the front-back direction.

When the crankshaft 16 pivots, the power from the crankshaft 16 is transmitted to the fuel pump 65 through the first sprocket 16a, the first chain 41a, and the second sprocket 65a. The fuel pump 65 is driven by the transmitted power.

Meanwhile, when the power transmitted from the crankshaft 16 causes the second sprocket 65a to pivot, the third sprocket 65b of the fuel pump 65 also pivots. Hence, the power is transmitted to the sprocket gears 22a and 27a through the second chain 41b. The transmitted power causes the intake camshaft 21 and the exhaust camshaft 26 to pivot. Then, the intake valves and the exhaust valves operate.

The above power transmission mechanism 40 is covered with a timing chain cover (a cover) 43. This timing chain cover 43 is provided in association with each of the cylinder head 14 and the cylinder block 13, and covers the left side face (specifically, the left side faces of the cylinder block 13, the cylinder head 14, and the head cover 15) of the engine 1.

The timing chain cover 43 is located between the engine 1 and the transmission 2 in the vehicle width direction. Specifically, the timing chain cover 43 is fastened to the left side face of the engine 1. In this fastened state, the transmission 2 is mounted on a left face of the timing chain cover 43. In other words, the engine 1 and the transmission 2 constitute a single unit through the timing chain cover 43.

The timing chain cover 43 according to this first embodiment includes: a first cover 43a on which the transmission 2 is mounted; and a second cover 43b provided above the first cover 43a and covering a side of the cylinder head 14 toward the transmission 2.

Specifically, as illustrated in FIGS. 6 to 8, the first cover 43a is mounted on the left side face of the cylinder block 13, and provided with an insertion hole of the crankshaft 16 and a fastener for fastening the transmission 2 on the first cover 43a.

In contrast, the second cover 43b is mounted on the left side faces of the cylinder head 14 and the head cover 15, and has not-shown openings each corresponding to one of the sprocket gears 22a and 27a. Hence, when the second cover 43b is mounted on the engine 1, the sprocket gears 22a and 27a are exposed from the second cover 43b through the openings. The S-VT motor 22b is mounted on the exposed portion of the sprocket gear 22a, and the S-VT motor 27b is mounted on the exposed portion of the sprocket gear 27a. As illustrated in FIG. 7, a protector is additionally attached to each of the mounted S-VT motors 22b and 27b so that the electric intake S-VT 22 and the electric exhaust S-VT 27 are configured.

Note that, as schematically illustrated in FIG. 4, a belt-driven power transmission mechanism (an accessory drive mechanism) 70 is provided to a side of the engine 1 across from the transmission 2; that is, specifically, a right side of the engine 1 (see FIG. 2). Specifically, the power transmission mechanism (the accessory drive mechanism) 70 drives various accessories of the engine 1 such as the water pump 71 and an air conditioner (not shown).

EGR Device

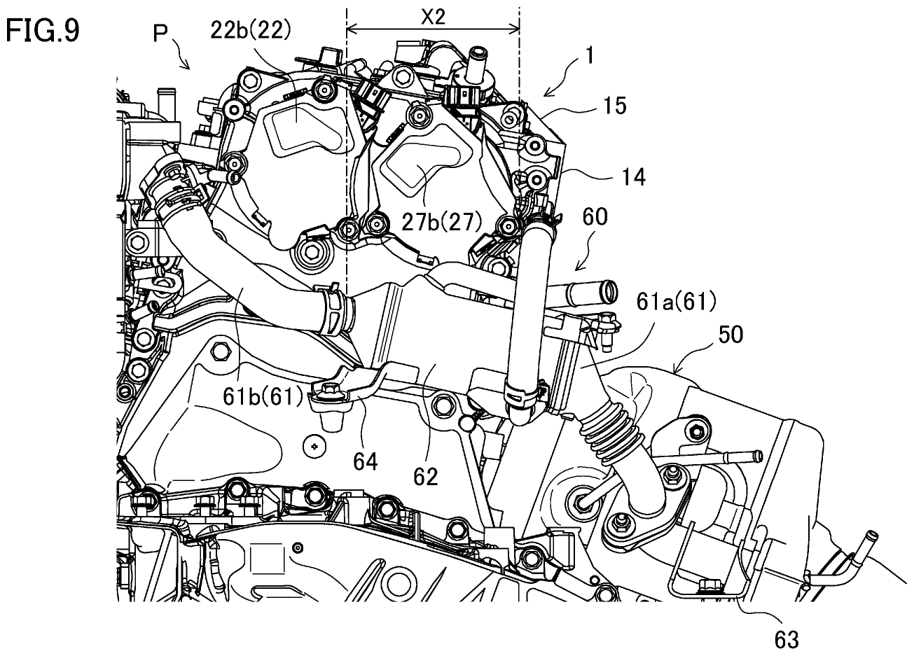

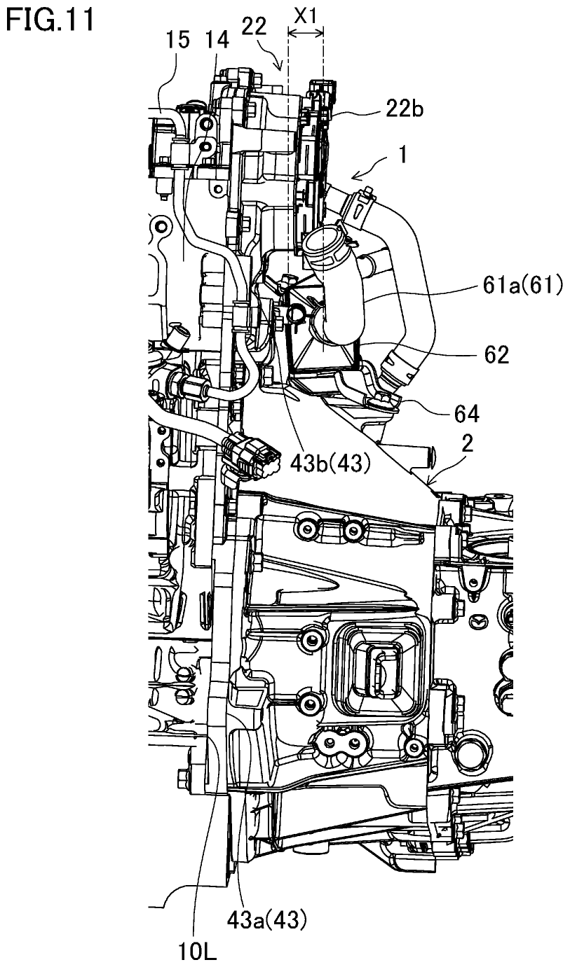

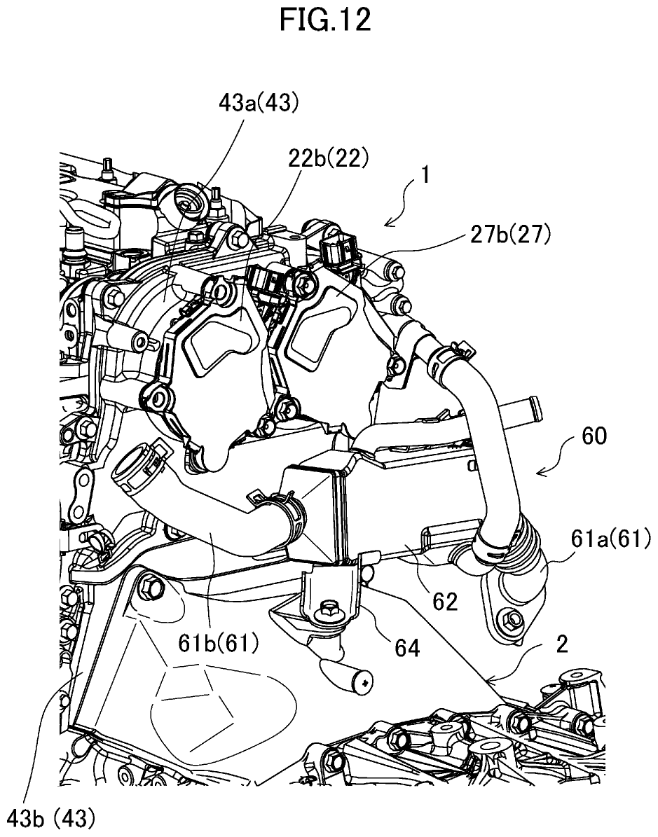

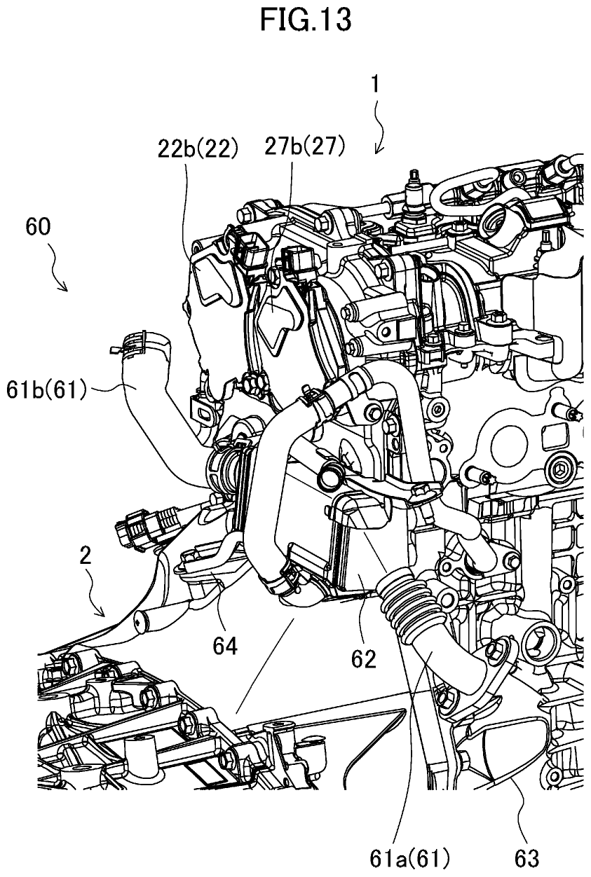

FIG. 9 illustrates how the electric intake S-VT 22 and the electric exhaust S-VT 27 as variable valve mechanisms and the EGR device 60 are located in relation to one another when viewed from the left. Moreover, FIG. 10 illustrates such relative locations viewed from above. FIG. 11 illustrates the relative locations viewed from the front. Furthermore, FIG. 12 illustrates a support structure of the EGR cooler 62 viewed from obliquely forward left. FIG. 13 illustrates the support structure viewed from obliquely backward left.

As illustrated in FIG. 9, the EGR passage 61 included in the EGR device 60 branches off from the exhaust passage 50 downstream of the exhaust emission control device 51, and is connected to the intake passage 30.

As already described, the EGR passage 61 has the EGR cooler 62 interposed therein to cool the gas passing through the EGR passage 61. Hereinafter, in the EGR passage 61, a connection between the exhaust passage 50 and the EGR cooler 62 is referred to as an upstream EGR passage 61a; whereas, a connection between the EGR cooler 62 and the intake passage 30 is referred to as a downstream EGR passage 61b.

Specifically, as illustrated in FIGS. 10 to 12, the upstream EGR passage 61a extends obliquely upward and forward along a left part of the exhaust passage 50. Then, the upstream EGR passage 61a turns left not to interfere with a left part of the engine body 10. Then, the upstream EGR passage 61a extends obliquely upward and forward again to reach the EGR cooler 62. As already described, the upstream end of the upstream EGR passage 61a is connected to the exhaust passage 50 downstream of the exhaust emission control device 51; whereas a downstream end (a front end) of the upstream EGR passage 61a is connected to an upstream end (a rear end) of the EGR cooler 62.

More specifically, as illustrated in FIGS. 9 and 10, the upstream EGR passage 61a is provided above the rear end of the transmission 2 in the vehicle height direction; whereas, in the vehicle width direction, the upstream EGR passage 61a is provided substantially in the same location of the electric intake S-VT 22 and the electric exhaust S-VT 27. Moreover, the upstream EGR passage 61a is provided with a first bracket 63. Although not shown in detail, the upstream EGR passage 61a is supported by the transmission 2 through the first bracket 63.

The EGR cooler 62 is shaped into a square tube slightly angled with respect to the front-rear direction. At least when the engine 1 is mounted in the vehicle, the EGR cooler 62 is provided in an orientation in which openings of both ends of the EGR cooler 62 face in the obliquely front-rear direction. The upstream end of the EGR cooler 62 is directed obliquely downward and backward, and, as already described, connected to the downstream end of upstream EGR passage 61a. Meanwhile, the downstream end (front end) of the EGR cooler 62 is directed obliquely upward and forward, and connected to the upstream end (rear end) of the downstream EGR passage 61b.

As illustrated in, for example, FIG. 10, the EGR cooler 62 has a cross-section perpendicular to the flow direction of the gas (i.e., a cross-sectional flow area) that is larger than the cross-sectional flow areas of the upstream EGR passage 61a and the downstream EGR passage 61b.

To be more specific, as illustrated in FIGS. 9, 10, and 11, the EGR cooler 62 is provided along the left side face of the cylinder head 14 toward the transmission 2. As can be seen from FIG. 11, in the vehicle width direction, the EGR cooler 62 is spaced apart from the second cover 43b mounted on the left side face of the cylinder head 14.

The EGR device 60 is located closer to the cylinder block 13 than to the electric intake S-VT 22 and the electric exhaust S-VT 27 in the direction from the cylinder head 14 toward the cylinder block 13 (in this exemplary configuration, substantially the same as the vehicle height direction). In addition, when viewed in the same direction, at least a part of the EGR device 60, the electric intake S-VT 22, and the electric exhaust S-VT 27 are arranged to overlap with one another.

Here, a double-headed arrow X1 in FIGS. 4 and 11, a double-headed arrow X2 in FIG. 9, and a double-headed arrow X3 in FIG. 10 each indicate how the EGR cooler 62 and the electric exhaust S-VT 27 are located in relation to each other. As indicated by the double-headed arrows X1 to X3, when the EGR device 60 is observed from the cylinder block 13 in the direction from the cylinder head 14 toward the cylinder block 13, the EGR cooler 62 and the electric exhaust S-VT 27 are arranged to overlap with each other. Specifically, the EGR cooler 62 and the exhaust electric motor S-VT 27 overlap with each other as defined by the double-headed arrows X1-X3 in each of the drawings.

Specifically, as illustrated in FIG. 10, the EGR cooler 62 is located below (in particular directly below) the electric exhaust S-VT 27 in the vehicle height direction, and above (in particular directly above) the transmission 2. That is, in the vehicle height direction, the EGR cooler 62 is located between the electric exhaust S-VT 27 and the transmission 2. In addition, when viewed from above in the vehicle height direction, the EGR cooler 62 and the electric exhaust S-VT 27 are arranged to overlap with each other.

Furthermore, as illustrated in FIGS. 12 and 13, the EGR cooler 62 is provided with a second bracket 64. The transmission 2 supports the EGR cooler 62 through the second bracket 64. Specifically, the second bracket 64 provided to the EGR cooler 62 is fastened to the center, in the vehicle front-rear direction, of a top face of the transmission 2.

The downstream EGR passage 61b extends upward as running along the flow of the gas from upstream to downstream. Specifically, as illustrated in FIGS. 9 and 10, the downstream EGR passage 61b extends obliquely upward and forward along the left part of the engine 1, and turns substantially forward. As already described, the upstream end (rear end) of the downstream EGR passage 61b is connected to the downstream end of upstream EGR cooler 62. Meanwhile, the downstream end (front end) of the downstream EGR passage 61b is connected to the rear of the intake passage 30.

To be more specific, as illustrated in FIGS. 9, 10, and 11, the downstream EGR passage 61b is provided along the left side face of the cylinder head 14 toward the transmission 2 as the EGR cooler 62 is provided so. In the vehicle width direction, the downstream EGR passage 61b is spaced apart from the second cover 43b mounted on the left side face of the cylinder head 14.

Moreover, as illustrated in FIG. 10, the downstream EGR passage 61b is located below (in particular directly below) the electric intake S-VT 22 in the vehicle height direction, and above (in particular directly above) the transmission 2. That is, in the vehicle height direction, the downstream EGR passage 61b is located between the electric intake S-VT 22 and the transmission 2.

Regarding Downsizing the Powertrain Unit

As described in the first embodiment, the electric intake S-VT 22 and the electric exhaust S-VT 27 may be mounted on the engine 1 provided with the EGR device 60. Such variable valve mechanisms could be mounted on the left ends of the intake camshaft 21 and the exhaust camshaft 26. Depending on how the variable valve mechanisms are located in relation to the EGR device 60, in particular to the EGR cooler 62 of the EGR device 60, the engine 1 would increase in size. This is disadvantageous in downsizing the powertrain unit P.

However, as illustrated in FIG. 4, the electric intake S-VT 22 and the electric exhaust S-VT 27 mounted on the engine 1 inevitably protrude from an end of the engine 1 along the engine output shaft. A space is defined below the protruding electric intake S-VT 22 and electric exhaust S-VT 27. Utilizing the space, the EGR device 60 can be provided in the space.

In particular, as illustrated in FIG. 10, at least a portion of the EGR device 60 (specifically, the EGR cooler 62) and the electric exhaust S-VT 27 acting as the variable valve mechanism (i.e., a part protruding from the engine 1 toward the left end in the engine output shaft direction) are arranged to overlap with each other when engine 1 is viewed from above. Such an arrangement can reduce the size of the engine 1 in the engine output shaft direction. As a result, the powertrain unit P can be downsized.

Hence, the powertrain unit P can be downsized.

Furthermore, the EGR cooler 62 has a cross-section perpendicular to the flow direction of the gas that is larger than the other elements that configure the EGR device 60, such as the EGR passage 61. As shown in FIG. 10, it is advantageous to downsize the engine 1, and hence the powertrain P, by having the EGR cooler 62 overlap with the electric exhaust S-VT 27.

In general, when an electric variable valve mechanism is used, reduction in heat damage is required.

On the other hand, the EGR cooler 62 can cool the gas that flows back as an external EGR gas. Thus, relatively lower temperature gas flows through the downstream EGR passage 61b, which is downstream of the EGR cooler in the EGR passage 61, compared to gas flowing through the upstream EGR passage 61a upstream of the EGR cooler.

As shown in FIG. 10, the downstream EGR passage 61b of the EGR device 60 having a relatively lower temperature is located below the electric intake S-VT 22. Hence, heat damage to the electric intake S-VT 22 can be reduced.

As shown in FIG. 4, the electric intake S-VT 22 and the electric exhaust S-VT 27 are respectively attached to the left ends of the intake camshaft 21 and the exhaust camshaft 26 toward the transmission 2. Thus, the left ends protrude to the left side in the engine output shaft direction (i.e., the camshaft central axis direction), and the transmission 2 is located below the left ends. A space is defined between the protruding portions and the transmission 2, and the EGR device 60 is arranged in that space. It is therefore advantageous to downsize the engine 1 and hence the powertrain unit P.

Generally, the EGR device 60 has been supported by the cylinder head 14 thus far. However, in such a configuration, it is required that the EGR device be removed from the cylinder head 14 in advance when the cylinder head 14 is to be removed in order to service the area around the intake camshaft 21 and the exhaust camshaft 26, such as by exchanging parts in the valve system.

The EGR device 60 includes multiple devices such as the EGR passage 61 connecting the exhaust passage 50 and the intake passage 30 of the engine 1, and the EGR cooler 62 for cooling burned gas. Hence, removing the EGR device 60 from the cylinder head 14 takes time, and thus is inconvenient for smooth service of the engine 1. In such a case, a space is required to store the removed EGR device 60. In view of the extra space required, the EGR device has room for improvement for smooth serviceability.

The EGR device 60 could be supported by the automotive body. However, such a support structure could transmit a vibration caused by an operation of the engine 1 to the automotive body through the EGR device 60 when the vibration enters the EGR device 60 through the intake passage 30 and the exhaust passage 50. The transmission of the vibration deteriorates noise vibration and harshness (NVH) characteristics of the vehicle, and is not preferable.

However, as shown in FIG. 12, the EGR device 60 according to the present embodiment is supported not by the cylinder head 14 but by the transmission 2. Hence, when the cylinder head 14 is to be removed, such a feature eliminates the need for a process of removing the EGR device 60 from the cylinder head 14. As a result, the feature successfully reduces the number of processes and hence improves serviceability of the powertrain unit P.

Compared with a configuration of supporting the EGR device 60 by the automotive body, supporting the EGR device 60 by the transmission 2 makes it possible to reduce the transmission of the vibration through the EGR device 60. This is advantageous in achieving NVH characteristics.

Such a support structure successfully improves serviceability of the powertrain unit P without deteriorating NVH characteristics.

### Second Embodiment

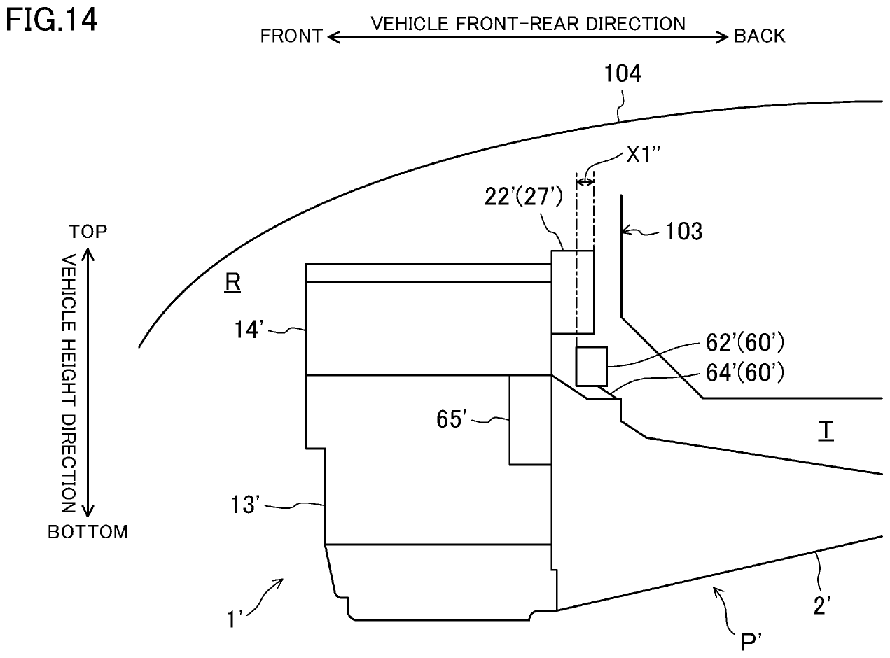

As a second embodiment, described next is a powertrain unit P′ mounted in a front-engine, rear-wheel drive, four-wheel vehicle (i.e., an FR vehicle). FIG. 14 corresponds to FIG. 4 and illustrates a schematic layout of the powertrain unit P′ for an FR vehicle.

Hereinafter, descriptions of configurations in common with those in the first embodiment will be omitted as appropriate.

The powertrain unit P′ includes an engine 1′ and a transmission 2′ coupled to the engine 1′. The engine 1′ is an inline-four longitudinal engine such that the engine front-rear direction (the cylinder bank direction) is substantially the same as the vehicle front-rear direction, and the engine width direction is substantially the same as the vehicle width direction. Meanwhile, the transmission 2′ transmits power of the engine 1′ to rotate and drive a drive shaft through a not-shown propeller shaft.

Similar to the first embodiment, the hood 104 gradually rises from the front to the rear in the vehicle front-rear direction.

For the engine 1′, the engine output shaft is arranged along the vehicle front-rear direction, and an electric intake S-VT 22′ and an electric exhaust S-VT 27′ face the dash panel 103 as a partition. Meanwhile, the transmission 2′ is located behind, and next to, the engine 1′, and inserted in the tunnel T of the dash panel 103.

Moreover, similar to the first embodiment, the fuel pump 65′ is provided across a left side face (i.e., a left side face 10L) of the engine 1 from the transmission 2. This is the equivalent of the fuel pump 65′ being arranged forward of the left side face 10L of the engine 1′ in the vehicle front-rear direction. Considering that the dash panel 103 is provided behind the engine 1′, such a feature is advantageous in reducing the risk of contact between the fuel pump 65′ and the dash panel 103 when, for example, the vehicle comes into collision.

Similar to the first embodiment, an EGR device 60′ is provided between (i) the electric intake S-VT 22′ and the electric exhaust S-VT 27′ and (ii) the transmission 2′ in the vehicle height direction. Although not shown in detail, at least a part of the EGR device 60′, the electric intake S-VT 22′, and the electric exhaust S-VT 27′ are arranged to overlap with one another when observed from above in the vehicle height direction. Such an arrangement makes it possible to downsize the powertrain unit P′ as seen in the first embodiment.

Furthermore, similar to the first embodiment, the EGR device 60′ is arranged along a side (a rear side) of the cylinder head 14′ toward the transmission 2′ and is supported by the transmission 2′ through a bracket (the second bracket 64′). Similar to the first embodiment, such a support structure successfully improves serviceability of the powertrain unit P′ without deteriorating NVH characteristics.

In recent years, the height of the hood 104 has been required to be lowered in view of a sophisticated design and improved aerodynamic characteristics of the motor vehicle 100′. Considering that a typical motor vehicle has the hood 104 gradually rising from the front toward the rear, the powertrain unit P′ needs to be provided toward the rear as much as possible, and such devices as the variable valve mechanism which could protrude above the cylinder head 14′ and the cylinder block 13′ are required to be provided to the rear of the engine 1′ in order to lower the overall height of the hood 104 without changing the size of the powertrain unit P′ itself.

As illustrated in FIG. 14, the engine 1′ is positioned so that the electric intake S-VT 22′ and the electric exhaust S-VT 27′ face the dash panel 103 provided behind the engine 1′. Such a positioning of the engine 1′ is equivalent to providing the electric intake S-VT 22′ and the electric exhaust S-VT 27′ to the rear of the engine 1′, which is advantageous in lowering the overall height of the hood 104.

In such a positioning, the electric intake S-VT 22′, the electric exhaust S-VT 27′, and the EGR device 60 are located in relation to one another as described above, so that the size of the engine 1′ can be reduced along the engine output shaft; that is, the vehicle front-rear direction. Hence, by the reduced size of the engine 1′ in the vehicle front-rear direction, the engine 1′ can be provided further toward the rear and closer to the dash panel 103. This allows the overall height of the hood 104 to be lowered.

Moreover, when the transmission 2′ is inserted in the tunnel T, the whole powertrain unit P′ can be provided to the rear of the engine compartment R. This is also advantageous in lowering the overall height of the hood 104.

### Third Embodiment

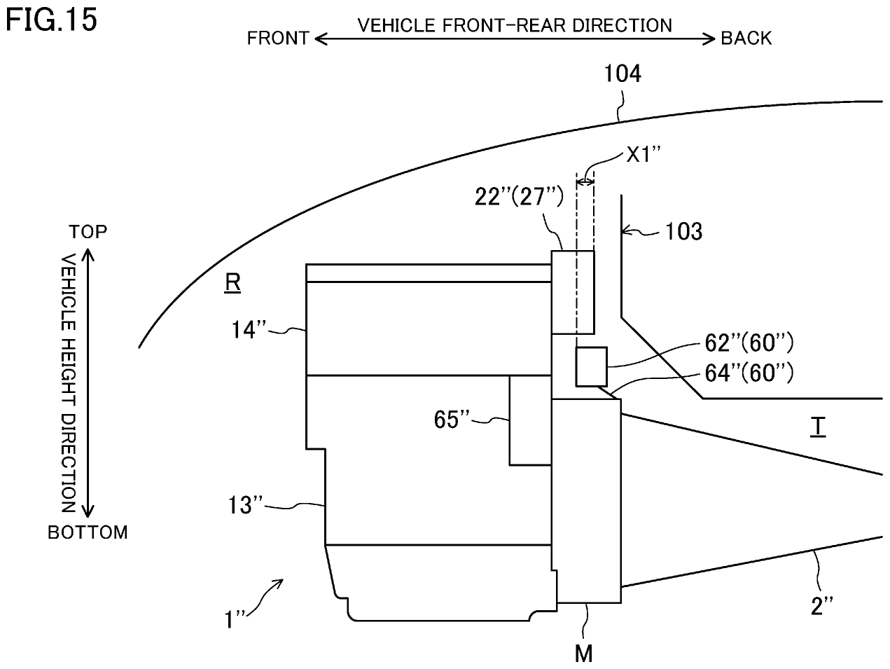

As a third embodiment, described next is a powertrain unit P″ mounted in a hybrid vehicle (HV) that is a front-engine, rear-wheel drive, and four-wheel vehicle. FIG. 15 corresponds to FIG. 4 and illustrates a schematic layout of the powertrain unit P″ for a hybrid vehicle (HV).

Hereinafter, descriptions of configurations in common with those in the first and second embodiments will be omitted as appropriate.

The powertrain unit P″ includes: an engine 1″; a transmission 2″ coupled to the engine 1″; and an HV motor (motor) M interposed between the engine 1″ and the transmission 2″. Similar to the second embodiment, the engine 1″ is an inline-four longitudinal engine such that the engine front-rear direction (the cylinder bank direction) is substantially the same as the vehicle front-rear direction, and the engine width direction is substantially the same as the vehicle width direction.

Here, the engine 1″ is in an orientation in which the electric intake S-VT 22″ and the electric exhaust S-VT 27″ face the dash panel 103. Meanwhile, the transmission 2″ is located to the rear of the engine 1″ across from the HV motor M, and inserted in the tunnel T of the dash panel 103 behind the engine 1″.

An EGR device 60″ is different from the EGR device 60 in the first embodiment and the EGR device 60′ in the second embodiment. The EGR device 60″ is provided between (i) the electric intake S-VT 22″ and the electric exhaust S-VT 27″ and (ii) the HV motor M in the vehicle height direction. Although not shown in detail, at least a part of the EGR device 60″, the electric intake S-VT 22″, and the electric exhaust S-VT 27″ are arranged to overlap with one another when observed from above in the vehicle height direction. Such an arrangement makes it possible to downsize the powertrain unit P″ as seen in the first and second embodiments.

Furthermore, in contrast to the first and second embodiments, the EGR device 60″ is arranged along a side (a rear side) of the cylinder head 14′ toward the HV motor M and is supported by the HV motor M through a bracket (the second bracket 64″). Similar to the first and second embodiments, such a support structure successfully improves serviceability of the powertrain unit P″ without deteriorating NVH characteristics.

### Other Embodiments

In the first to third embodiments, the electric intake S-VT 22, the electric exhaust S-VT 27, and the EGR device 60 are arranged in the rear of the engine 1; however, the arrangement shall not be limited to such an arrangement. For example, the electric intake S-VT 22, the electric exhaust S-VT 27, and the EGR device 60 may be provided in the front of the engine 1.

In the first embodiment, the EGR cooler 62 is only supported by the transmission 2; however, the first embodiment is not limited to this configuration. For example, the EGR cooler 62 can be supported by the cylinder block 13 and the transmission 2. Even such a support structure improves serviceability around the cylinder head 14.

Furthermore, in the first embodiment, the power transmission mechanism 40 is a gear drive system through the timing chain 41. However, the power transmission mechanism 40 shall not be limited to such a drive system. For example, the power transmission mechanism 40 may be a belt drive system.

### DESCRIPTION OF REFERENCE CHARACTERS

1 Engine
2 Transmission
21 Intake Camshaft (Camshaft)
22 Electric Intake S-VT (Variable Valve Mechanism)
26 Exhaust Camshaft (Camshaft)
27 Electric Exhaust S-VT (Variable Valve Mechanism)
30 Intake Passage
50 Exhaust Passage
60 EGR Device
61 EGR Passage
61b Downstream EGR Passage
62 EGR Cooler
65 Fuel Pump
100 Motor Vehicle (Vehicle)
103 Dash Panel (Partition)
104 Hood
P Powertrain Unit (Automotive Powertrain Unit)
R Engine Compartment
T Tunnel

1. A vehicle powertrain unit including an engine comprising:
an engine body including a cylinder block and a cylinder head coupled to the cylinder block;
a camshaft arranged at the cylinder head and extending in an engine front-rear direction;
a variable valve mechanism that is mounted on one end of the camshaft and changes a rotational phase of the camshaft;
an intake passage connected to one side face of the engine body and an exhaust passage connected to a side face opposite to the one side face of the engine body; and
an EGR device provided outside the engine body and connecting the intake passage and the exhaust passage together, wherein
the EGR device is located closer to the cylinder block than the variable valve mechanism in a direction from the cylinder head toward the cylinder block, and is arranged so that at least a part of the EGR device and the variable valve mechanism overlap with each other when viewed in the direction from the cylinder head toward the cylinder block.

2. The vehicle powertrain unit of claim 1, wherein
the EGR device includes an EGR passage connecting the intake passage and the exhaust passage together and an EGR cooler interposed in the EGR passage, and
the EGR device is arranged so that the EGR cooler and the variable valve mechanism overlap with each other when viewed in the direction from the cylinder head toward the cylinder block.

3. The vehicle powertrain unit of claim 2, wherein
the variable valve mechanism is configured as an electric mechanism, and
the EGR cooler and a portion of the EGR passage downstream of the EGR cooler are arranged below the variable valve mechanism.

4. The vehicle powertrain unit of claim 1, further comprising:
a transmission coupled to an end of the cylinder block in an engine output shaft direction, wherein
the variable valve mechanism is mounted to an end of the camshaft toward the transmission, and the EGR device is arranged between the variable valve mechanism and the transmission.

5. The vehicle powertrain unit of claim 4, wherein
the EGR device is supported by the transmission.

6. The vehicle powertrain unit of claim 4, wherein
an engine compartment in which the engine is mounted includes:
a hood arranged above the engine and rising from front to rear in a vehicle front-rear direction; and
a partition arranged behind the engine and defining at least a rear face of the engine compartment, wherein
the partition includes a tunnel located behind the engine and extending in the vehicle front-rear direction,
the engine is positioned so that the engine output shaft is arranged along the vehicle front-rear direction and that an end of the engine toward the variable valve mechanism is oriented to face the partition, and
the transmission is located behind the engine and is inserted in the tunnel.

7. The vehicle powertrain unit of claim 6, wherein
a fuel pump is attached to the engine, and
the fuel pump is arranged forward of an end face of the engine toward the transmission on in the vehicle front-rear direction.

8. A vehicle powertrain unit including an engine comprising:
an engine body including a cylinder block and a cylinder head coupled to the cylinder block;
a camshaft arranged at the cylinder head and extending in an engine front-rear direction;
a variable valve mechanism that is mounted on one end of the camshaft and changes a rotational phase of the camshaft;
an intake passage connected to one side face of the engine body and an exhaust passage connected to a side face opposite to the one side face of the engine body; and
an EGR device provided outside the engine body and connecting the intake passage and the exhaust passage together, wherein
the EGR device is located closer to the cylinder block than the variable valve mechanism in a direction from the cylinder head toward the cylinder block, and is arranged so that at least a part of the EGR device and the variable valve mechanism overlap with each other when viewed along the direction from the cylinder head toward the cylinder block while facing the cylinder block,
the EGR device includes an EGR passage connecting the intake passage and the exhaust passage together and an EGR cooler interposed in the EGR passage,
the EGR device is arranged so that the EGR cooler and the variable valve mechanism overlap with each other when viewed along the direction from the cylinder head toward the cylinder block while facing the cylinder block,
the variable valve mechanism is configured as an electric mechanism, and
the EGR cooler and a portion of the EGR passage downstream of the EGR cooler are arranged below the variable valve mechanism.
